(19) United States
(12) Patent Application Publication
(10) Pub. No.: US 2017/0171833 A1
(43) Pub. Date: Jun. 15, 2017

(54) OPTIMIZING NETWORK CONNECTION AND ROAMING USING RANGING INFORMATION

(71) Applicant: QUALCOMM Incorporated, San Diego, CA (US)

(72) Inventors: Santosh Vamaraju, San Jose, CA (US); Hoonki Lee, San Jose, CA (US); Carlos Horacio Aldana, Mountain View, CA (US); Ravi Gidvani, Fremont, CA (US)

(21) Appl. No.: 15/373,560

(22) Filed: Dec. 9, 2016

Related U.S. Application Data
(60) Provisional application No. 62/266,531, filed on Dec. 11, 2015.
(60) Provisional application No. 62/401,576, filed on Sep. 29, 2016.

(51) Int. Cl. H04W 60/04; H04W 48/20; H04W 36/30; H04W 36/00; H04W 8/14

(52) U.S. Cl. CPC H04W 60/04; H04W 36/0094; H04W 8/14; H04W 36/30; H04W 48/20

(57) ABSTRACT

This disclosure provides systems, methods and apparatus for establishing and maintaining network connections based on ranging information. In one aspect, a wireless device is configured to identify one or more candidate access points (APs) within a vicinity of the wireless device, and exchange fine timing measurement (FTM) frames with candidate APs to determine respective distances between the wireless device and each of the candidate APs. In some aspects, the exchange of FTM frames may be performed when the wireless device is not associated with any AP. In some other aspects, the exchange of FTM frames may be performed when the wireless device is already associated with an existing AP, for example, to determine whether a roaming condition is satisfied. The wireless device then selects one of the candidate APs, based at least in part on the FTM frames, and associates with the selected candidate AP.

### CROSS-REFERENCE TO RELATED APPLICATIONS

This application claims priority under 35 U.S.C. 119(e) to co-pending and commonly owned U.S. Provisional Patent Application No. 62/266,531 entitled “OPTIMIZING WLAN ROAMING USING LOCATION INFORMATION” filed on Dec. 11, 2015, and to co-pending and commonly owned U.S. Provisional Patent Application No. 62/401,576 entitled “OPTIMIZING NETWORK CONNECTION AND ROAMING USING RANGING INFORMATION” filed on Sep. 29, 2016, the entireties of both of which are incorporated by reference herein.

### TECHNICAL FIELD

This disclosure relates generally to wireless networks, and specifically to improving the performance and efficiency of establishing and maintaining network connections based on ranging information.

### DESCRIPTION OF THE RELATED TECHNOLOGY

A wireless local area network (WLAN) may be formed by one or more access points (APs) that provide a shared wireless communication medium for use by a number of client devices or stations (STAs). Establishing a wireless connection between an AP and a STA involves a number of steps that must be completed before the STA and AP can begin exchanging data with one another. First, the STA typically scans all available wireless channels (such as by broadcasting probe requests or listening for beacon frames) to identify APs or other devices that are within wireless communication range. Each probe response or beacon frame transmitted by an available AP may contain basic service set (BSS) information pertaining to the AP's network or WLAN. Next, the STA selects one of the APs to connect to, for example, based on the associated network information. Typically, the STA may select the AP with the highest received signal strength indication (RSSI). The STA then authenticates and associates with the selected AP.

As the STA moves through a given environment, the quality of communications with the associated AP may fluctuate. For example, the perceived signal quality of the WLAN may degrade as the STA moves further away from the associated AP. This may result in reduced throughput or termination of the communication link. To prevent this result, the IEEE 802.11 specification defines a roaming process, whereby the STA may seamlessly transfer communications over (such as by reassociating) to another AP in the WLAN. Typically, roaming is triggered when the RSSI of the associated AP (as measured by the STA) falls below a threshold level. Upon detecting the drop in RSSI, the STA may begin scanning for a new AP to associate with. For example, while the STA is still associated with the current AP, the STA may scan for other APs in the vicinity that may provide better quality or throughput of communications than the associated AP.

Scanning operations may consume a significant amount of power and time. Furthermore, RSSI may not be a reliable metric for determining whether to associate with a particular AP. For example, temporary obstructions or other sources of interference may cause sudden spikes or dips in the RSSI perceived by the STA, which may cause the STA to determine that its overall quality of communications with a particular AP is better or worse than it actually is.

### SUMMARY

The systems, methods and devices of this disclosure each have several innovative aspects, no single one of which is solely responsible for the desirable attributes disclosed herein.

One innovative aspect of the subject matter described in this disclosure can be implemented in a method of operating a wireless device. The method may include steps of identifying one or more candidate access points (APs) within a vicinity of the wireless device, exchanging fine timing measurement (FTM) frames with the one or more candidate APs to determine respective distances between the wireless device and each of the one or more candidate APs, selecting one of the one or more candidate APs to associate with based at least in part on the FTM frames, and associating with the selected candidate AP.

In some implementations, the selected candidate AP may correspond to the candidate AP that is closest to the wireless device. In some other implementations, the candidate AP selection may further include steps of detecting signal strengths of the frames received from the one or more candidate APs, and selecting the one of the one or more candidate APs based at least in part on the respective distances and the signal strengths associated with each of the one or more candidate APs.

In some implementations, the exchanging of FTM frames may be performed when the wireless device is not associated with any AP. For example, aspects of the disclosure may be implemented by the wireless device when attempting to establish a connection to a wireless network. In some other implementations, the exchanging of FTM frames may be performed when the wireless device is associated with an existing AP. For example, aspects of the disclosure may be implemented by the wireless device when attempting roam to another candidate AP.

In some implementations, the associating may further include steps of detecting that a roaming condition is satisfied based at least in part on the FTM frames and associating with the selected AP upon detecting that the roaming condition is satisfied. In some implementations, the roaming condition may be satisfied when the wireless device is at least a threshold distance away from the existing AP. In some other implementations, the roaming condition may be satisfied when the wireless device is closer to at least one of the candidate APs than to the existing AP.

In some implementations, the method may further include steps of detecting a presence of an obstruction in the vicinity of the wireless device based at least in part on the FTM frames, and selectively filtering the one or more candidate APs based on the presence of the obstruction. In some implementations, the selectively filtering may be performed by detecting signal strengths of the FTM frames received from the one or more candidate APs, and determining whether the obstruction is temporary or permanent based at least in part on the respective distances and the signal strengths associated with each of the one or more candidate APs. The wireless device may then filter the one or more candidate APs if the detected obstruction is permanent.

Another innovative aspect of the subject matter described in this disclosure can be implemented in a wireless device. The wireless device includes one or more processors and a memory storing instructions that, when executed by the one or more processors, cause the wireless device to identify one or more candidate APs within a vicinity of the wireless device, exchange FTM frames with the one or more candidate APs to determine respective distances between the wireless device and each of the one or more candidate APs, select one of the one or more candidate APs to associate with based at least in part on the FTM frames, and associate with the selected candidate AP.

In some implementations, the selected candidate AP may correspond to the candidate AP that is closest to the wireless device. In some other implementations, execution of the instructions to select one of the candidate APs may cause the wireless device to detect signal strengths of the FTM frames received from the one or more candidate APs, and select the one of the one or more candidate APs based at least in part on the respective distances and the signal strengths associated with each of the one or more candidate APs.

In some implementations, the exchange of FTM frames may be performed when the wireless device is not associated with any AP (such as when attempting to establish a connection to a wireless network). In some other implementations, the exchange of FTM frames may be performed when the wireless device is associated with an existing AP (such as when attempting to roam to another candidate AP).

In some implementations, execution of the instructions to associate with the selected candidate AP may further cause the wireless device to detect that a roaming condition is satisfied based at least in part on the FTM frames and associate with the selected AP upon detecting that the roaming condition is satisfied. In some implementations, the roaming condition may be satisfied when the wireless device is at least a threshold distance away from the existing AP. In some other implementations, the roaming condition may be satisfied when the wireless device is closer to at least one of the candidate APs than to the existing AP.

In some implementations, execution of the instructions may further cause the wireless device to detect a presence of an obstruction in the vicinity of the wireless device based at least in part on the FTM frames, and selectively filter the one or more candidate APs based on the presence of the obstruction. In some implementations, execution of the instructions to selectively filter the one or more candidate APs may cause the wireless device to detect signal strengths of the FTM frames received from the one or more candidate APs, and determine whether the obstruction is temporary or permanent based at least in part on the respective distances and the signal strengths associated with each of the one or more candidate APs.

Another innovative aspect of the subject matter described in this disclosure can be implemented in a non-transitory computer-readable medium. The non-transitory computer-readable medium may include instructions that, when executed by one or more processors of a wireless device, cause the wireless device to identify one or more candidate APs within a vicinity of the wireless device, exchange FTM frames with the one or more candidate APs to determine respective distances between the wireless device and each of the one or more candidate APs, select one of the one or more candidate APs to associate with based at least in part on the FTM frames, and associate with the selected candidate AP.

In some implementations, execution of the instructions for associating with the selected candidate AP may cause the wireless device to detect that a roaming condition is satisfied based at least in part on the FTM frames and associate with the selected AP upon detecting that the roaming condition is satisfied.

In some implementations, execution of the instructions may further cause the wireless device to detect a presence of an obstruction in the vicinity of the wireless device based at least in part on the FTM frames, and selectively filter the one or more candidate APs based on the presence of the obstruction.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIGS. 1A and 1B show block diagrams of a wireless system.

FIG. 2 shows a sequence diagram depicting a ranging operation that may be used in a candidate AP selection process.

FIG. 3 shows an example wireless system in which a station (STA) may identify candidate APs using fine timing measurement (FTM) frames.

FIGS. 4A-4C show example wireless systems in which a STA may identify candidate APs for roaming using neighbor reports.

FIG. 5 shows a block diagram of a wireless device.

FIG. 6 shows a flowchart depicting a range-based candidate AP selection operation.

FIG. 7 shows a flowchart depicting a range-based roaming candidate selection operation.

FIG. 8 shows a flowchart depicting an example operation for triggering a roaming condition based on ranging information.

FIG. 9 shows a flowchart depicting an example operation for selecting a candidate AP to associate with based on ranging information.

FIG. 10 shows a flowchart depicting an example operation for detecting and classifying obstructions in a wireless medium based on ranging information.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, system or network that is capable of transmitting and receiving RF signals according to any of the IEEE 16.11 standards, or any of the IEEE 802.11 standards, the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless, cellular or internet of things (IOT) network, such as a system utilizing 3G, 4G or 5G, or further implementations thereof, technology.

As described above, in conventional scanning operations, a wireless station (STA) will typically associate with an access point (AP) that exhibits the highest signal strength (RSSI) among a plurality of available APs in the vicinity of the STA. However, signal strength may not be a reliable indicator of wireless performance. For example, due to movement of the STA, or interference in the wireless medium, the signal strength exhibited by a particular AP may spike or dip at any given instance of time. Thus, it is noted that the distance or proximity between a STA and a candidate AP may be a better indicator of actual wireless performance. For example, the quality of communications between two devices in relatively close proximity tends to be greater than the quality of communications between two devices that are farther apart. Thus, the implementations described herein may enable a STA to determine the distances (as ranging information) of nearby APs, and select a particular AP to associate with based on the corresponding distances. More specifically, in accordance with some implementations, the STA may associate with a candidate AP that is closest in proximity to the STA, even if another candidate AP exhibits superior signal strength at the time of association. Aspects of the disclosure may be implemented when performing a scanning operation (when selecting an AP to initially associate with) or a roaming operation (when selecting a best candidate AP to roam to).

Particular implementations of the subject matter described in this disclosure can be implemented to realize one or more of the following potential advantages. The implementations may improve the performance of network connections. For example, by using ranging information to select a candidate AP to associate with, a STA may select the candidate AP that is likely to offer the highest quality of communications over an extended period of time. It is noted that ranging operations may be performed when determining the location or position of a wireless device. Accordingly, certain aspects of the disclosure may leverage the information acquired during conventional ranging operations in selecting a candidate AP to associate with. Some aspects of the disclosure also may improve the efficiency of roaming operations. For example, when a roaming condition is satisfied, the STA may initiate ranging protocols for the purpose of locationing—or in lieu of a conventional scanning operation—to select a candidate AP to roam to. This may reduce the amount of time the STA spends off-channel (such as the per-channel dwell time) when identifying or selecting a new candidate AP to associate with, and may result in more controlled burst durations.

In the following description, numerous specific details are set forth such as examples of specific components, circuits, and processes to provide a thorough understanding of the present disclosure. The term “coupled” as used herein means connected directly to or connected through one or more intervening components or circuits. The term “associated AP” refers to an AP that a given STA is currently associated and/or connected to (such that there is an established communication channel or link between the AP and the given STA). The term “candidate AP” refers to any AP in the vicinity (such as within wireless range) of the STA and with which the STA may associate (such as during a channel scan and/or roaming operation). The term “obstruction,” as used herein, refers to any source of interference (such as physical objects or electromagnetic waves) that may inhibit or degrade wireless communications between a STA and an AP. In addition, although described herein in terms of exchanging data frames between wireless devices, the implementations may be applied to the exchange of any data unit, packet, and/or frame between wireless devices. Thus, the term “frame” may include any frame, packet, or data unit such as, for example, protocol data units (PDUs), MAC protocol data units (MPDUs), and physical layer convergence procedure protocol data units (PPDUs).

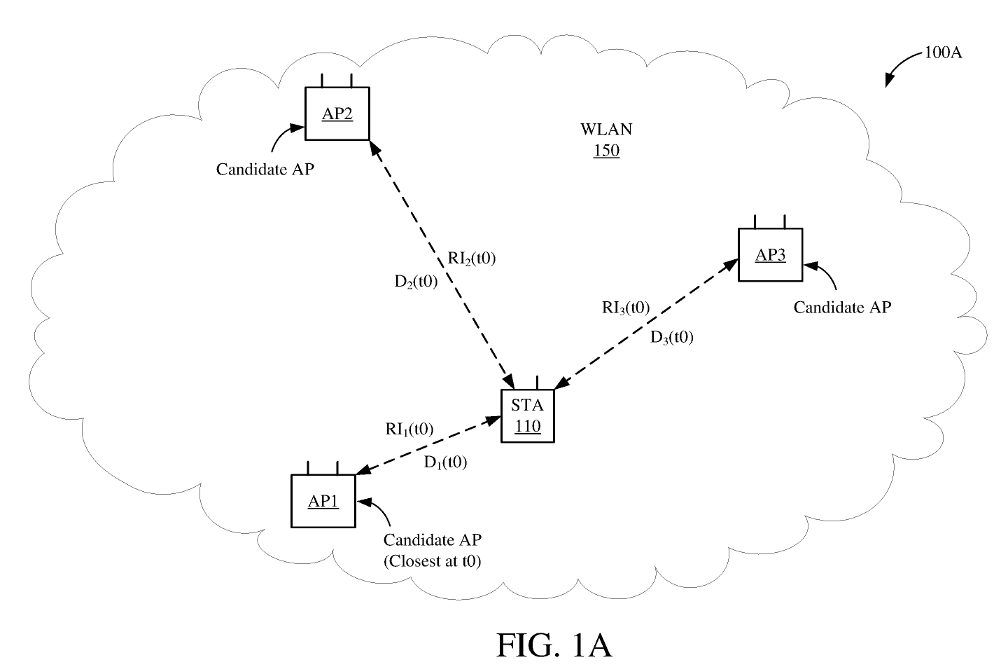

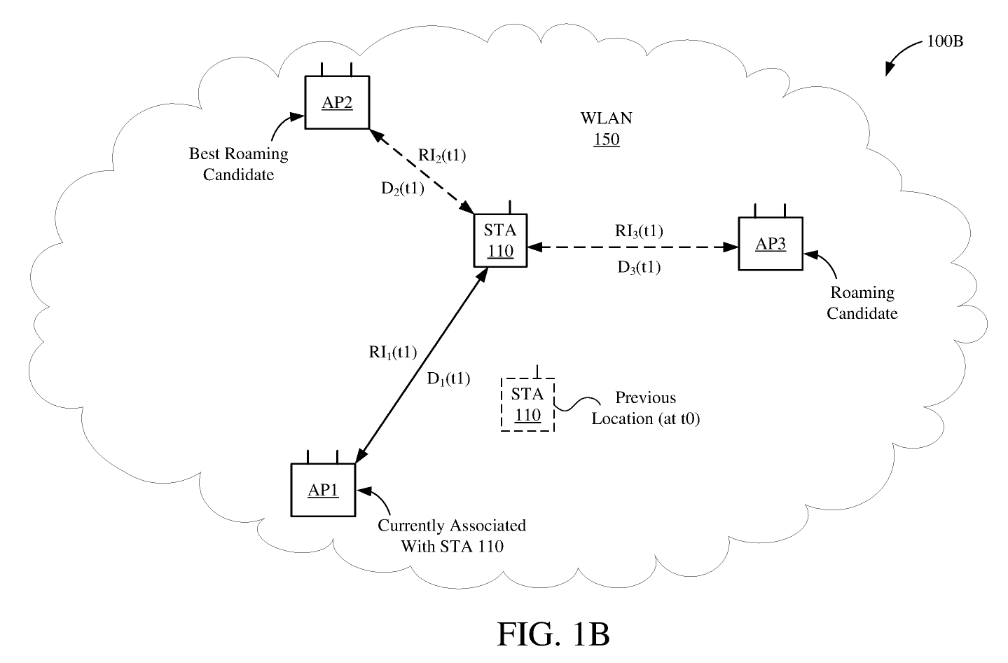

FIG. 1A shows a block diagram of a wireless system 100A. The wireless system 100 is shown to include a wireless station (STA) 110, a number of access points AP1-AP3, and a wireless local area network (WLAN) 150. The WLAN 150 may be formed by a plurality of Wi-Fi access points (such as AP1-AP3) that may operate according to the IEEE 802.11 family of standards (or according to other suitable wireless protocols). Thus, although only three access points AP1-AP3 are shown in FIG. 1A for simplicity, it is to be understood that WLAN 150 may be formed by any number of access points. Although the WLAN 150 is depicted in FIG. 1A as an infrastructure basic service set (BSS), for some other implementations, WLAN 150 may be a peer-to-peer (P2P) network (such as a network operating according to the Wi-Fi Direct protocols).

The STA 110 may be any suitable Wi-Fi enabled wireless device including, for example, a cell phone, personal digital assistant (PDA), tablet device, laptop computer, or the like. The STA 110 also may be referred to as a user equipment (UE), a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. For at least some implementations, the STA 110 may include one or more transceivers, one or more processing resources (such as processors or ASICs), one or more memory resources, and a power source (such as a battery). The memory resources may include a non-transitory computer-readable medium (such as one or more nonvolatile memory elements, such as EPROM, EEPROM, Flash memory, a hard drive, etc.) that stores instructions for performing operations described below.

One or more of the access points AP1-AP3 may include any suitable device that allows one or more wireless devices to connect to a network (such as a local area network (LAN), wide area network (WAN), metropolitan area network (MAN), or the Internet) via an AP using Wi-Fi, Bluetooth, or any other suitable wireless communication standards. For some implementations, one or more of the access points AP1-AP3 may be any suitable wireless device (such as a wireless STA) acting as a software-enabled access point (“SoftAP”). For at least one implementation, each AP may include one or more transceivers, one or more processing resources (such as processors or ASICs), one or more memory resources, and a power source. The memory resources may include a non-transitory computer-readable medium (such as one or more nonvolatile memory elements, such as EPROM, EEPROM, Flash memory, a hard drive, etc.) that stores instructions for performing operations described below.

To establish a connection with the WLAN 150, the STA 110 may initially scan one or more wireless channels to identify one or more of the access points AP1-AP3 within the WLAN 150. For example, the STA 110 may discover the access points AP1-AP3 through passive channel scanning or active channel scanning operations. During passive channel scanning, the STA 110 may “listen in” on each of the wireless channels to detect beacon frames, broadcast by the access points AP1-AP3, indicating the identity or capabilities of each respective AP (such as BSSID, SSID, WLAN configurations, etc.). During active channel scanning, the STA 110 may send probe requests on each of the wireless channels to elicit probe responses from the access points AP1-AP3 indicating the identity or capabilities of each respective AP.

Each of the access points AP1-AP3 identified during a channel scanning operation may be referred to as a “candidate” AP. Since each of the candidate access points AP1-AP3 are associated with the WLAN 150, the access points AP1-AP3 may have the same service set identifier (SSID). The STA 110 then analyzes one or more metrics associated with each of the candidate access points AP1-AP3 to select a particular AP to associate with, for example, to connect to the WLAN 150. For example, the STA 110 may measure a received signal strength indication (RSSI) of wireless signals (such as beacon or probe response frames) received from each of the access points AP1-AP3. In conventional implementations, the STA 110 typically associates with the candidate AP having the highest signal strength (RSSI). However, merely selecting the candidate AP with the highest RSSI at any given instant may not result in the “optimal” candidate selection for the STA 110.

For example, due to movement of the STA 110, obstructions in the WLAN 150, or other sources of signal interference, the STA 110 may perceive a spike or dip in the RSSI for a particular AP at any given instant compared to the average RSSI exhibited by that AP over an extended period of time. Thus, by simply selecting the candidate AP with the highest RSSI at a given instant, the STA 110 could potentially associate with a candidate AP that provides poorer wireless performance than other candidate APs over an extended period of time. It is noted that the physical distance (D) between the STA 110 and a particular candidate AP may be a better indicator of wireless performance than RSSI alone. Typically, the closer the STA 110 is to a particular AP, the better the quality of communications (such as throughput, beamforming, signal-to-noise ratio, etc.) between the two devices.

In some implementations, the STA 110 may use ranging information (RI) in selecting a particular candidate AP to associate with. The ranging information may indicate respective distances between the STA 110 and one or more candidate APs. Unlike RSSI, the ranging information more accurately describes the physical distance between the STA 110 and a candidate AP, and may thus be a more reliable indicator of the expected performance of the communications link between the STA 110 and the candidate AP. In some aspects, the STA 110 may determine the ranging information based on known locations or coordinates of the candidate APs and the STA 110 (such as global positioning system (GPS) coordinates or location configuration information (LCI) received from one or more of the access points AP1-AP3). In some other aspects, the STA may determine the ranging information based at least in part on a round-trip time (RTT) between wireless signals (such as fine timing measurement (FTM) frames) transmitted to or from the candidate AP.

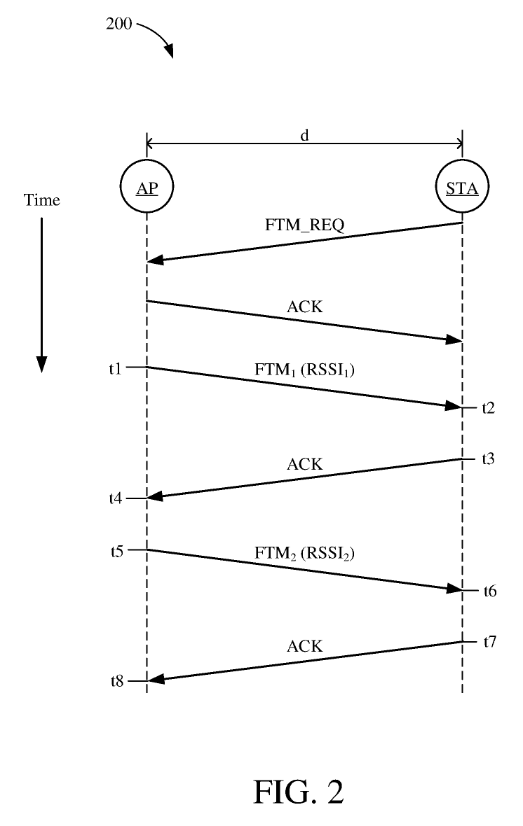

After performing an initial channel scan (to detect the presence or identities of the candidate access points AP1-AP3), the STA 110 may then initiate a ranging operation with one or more of the candidate APs. In some implementations, the ranging operation may be implemented according to an FTM protocol described by the IEEE 802.11REVmc specification. As described in greater detail with respect to FIG. 2, the ranging information may include timing information for FTM frames exchanged between the STA 110 and a corresponding AP. The timing information may be used to calculate an RTT for communications between the STA 110 and the AP. Thereafter, the RTT may be converted to a distance measurement indicating the physical distance between the STA 110 and the corresponding AP. In this manner, the STA 110 may use the ranging information to measure its distance to each of the candidate access points AP1-AP3.

For some implementations, when selecting a candidate AP to associate with, the STA 110 may first filter the set of candidate APs (identified during the scanning operation) based on their ability to support FTM ranging operations. For example, each of the access points AP1-AP3 may provide an extended capabilities information element (IE), in their respective beacon or probe response frames, indicating the capabilities supported by the particular AP. The STA 110 may parse the extended capabilities IE from the beacon or probe response frames received from each of the access points AP1-AP3 to determine which, if any, of the access points AP1-AP3 is capable of FTM ranging.

In the example of FIG. 1A, the STA 110 may determine that each of the access points AP1-AP3 supports FTM ranging. Thus, the STA 110 may initiate a respective ranging operation with each of the access points AP1-AP3 once the channel scan is completed. More specifically, at a given time t0, the STA 110 may acquire ranging information RI₁-RI₃ for each of the candidate access points AP1-AP3, respectively, using an FTM frame exchange protocol (such as described in greater detail with respect to FIG. 2). The STA 110 may further calculate distances D₁-D₃ to each of the candidate access points AP1-AP3 based on the ranging information RI₁-RI₃, respectively. The STA 110 may then select the closest candidate AP to associate with. In the example of FIG. 1A, AP1 is the closest candidate AP to STA 110 at the given time (D₁<D₃<D₂ at time t0). Thus, at time t0, STA 110 may connect to the WLAN 150 by associating with AP1.

The quality of the communications link between the STA 110 and AP1 (the “associated” AP) may fluctuate as the STA 110 moves or “roams” within the WLAN 150 or to another wireless network. More specifically, the quality of the link between the STA 110 and AP1 may deteriorate as the STA 110 moves further away from AP1. For example, the distances D₁-D₃ between the STA 110 and the respective access points AP1-AP3 may change as the STA 110 moves through the given environment (such as within WLAN 150). As a result, the wireless performance of the associated AP (AP1) may deteriorate while the wireless performance of the other access points AP2 or AP3 may improve over time. At a given distance, the STA 110 may achieve better wireless performance by associating with a different AP that is closer to the STA 110 than the currently associated AP, even though the STA 110 may still be within wireless range of the currently associated AP.

A “roaming” condition may be triggered when the STA 110 moves at least a threshold distance away from the associated AP. In conventional implementations, a roaming condition is triggered when the RSSI of the associated AP (as perceived by the STA 110) falls below a threshold level. When the roaming condition is triggered, the STA 110 would typically perform a subsequent channel scanning operation (such as a roaming scan) to once again identify candidate APs within wireless range of the STA 110. The STA 110 may then “roam” to, or associate with, a new candidate AP which may offer better wireless performance than the currently associated AP. However, as described above, instantaneous RSSI may not be a reliable indicator of wireless performance over an extended period of time. Thus, under conventional implementations, the STA 110 may unnecessarily trigger roaming scans in response to instantaneous changes in RSSI.

Moreover, conventional scanning operations may consume a significant amount of power and time. For example, on average, it may take 40-110 ms for the STA 110 to scan a single wireless channel (where typical scanning operations may involve scanning several wireless channels). Furthermore, while performing a scanning operation, the STA 110 may periodically return to its “home” channel to listen for beacons from the associated AP (such as to maintain connectivity with the WLAN 150). As a result, a conventional scanning operation may take up to ˜10 seconds to complete. The amount of time that the STA 110 must remain on each wireless channel, during the scanning operation, may be a burden on power consumption and medium usage, and may potentially disrupt communications among other devices in the WLAN 150.

Therefore, in some implementations, the STA 110 may use the ranging information RI₁-RI₃ or distances D₁-D₃ to determine when to trigger a roaming condition. When a roaming condition is triggered or satisfied, the STA 110 may select, or attempt to identify, a new candidate AP to associate with. In some aspects, the STA 110 may trigger a roaming condition when it is at least a threshold distance away from the currently associated AP (AP1). In some other aspects, the STA 110 may trigger a roaming condition when it is closer to another AP (such as AP2 or AP3) than the currently associated AP. When the roaming condition is triggered, the STA 110 may initiate a roaming scan to identify and select a new candidate AP to associate with. For at least some implementations, the STA 110 may use the ranging information RI₁-RI₃ or distances D₁-D₃ to select the new candidate AP, for example, without performing a roaming scan).

For example, the STA 110 may store the ranging information RI₁-RI₃ or distances D₁-D₃ associated with the access points AP1-AP3, respectively, in a table or database (such as a candidate AP database). As the STA 110 moves through the given environment, the STA 110 may periodically perform ranging operations (such as by exchanging FTM frames) with each of the access points AP1-AP3 to update the ranging information RI₁-RI₃ or distances D₁-D₃ stored in the candidate AP database. Unlike probe request/response frames, FTM frames may be exchanged in controlled bursts (typically lasting between 250 μs to 128 ms in duration, compared to ˜40 ms to receive a typical probe response). Thus, by using FTM ranging operations to analyze the candidate APs (in lieu of conventional roaming scans), the implementations described herein may significantly reduce the per-channel dwell time of the STA 110 when identifying or selecting a new candidate AP to associate with.

With reference for example to FIG. 1B, the STA 110 may be moving in a direction away from the associated AP (AP1). More specifically, at time t1, the STA 110 may be further away from AP1 and closer to the other access points AP2 and AP3 (compared to time t0). The STA 110 may record updated ranging information RI₁-RI₃ and distances D₁-D₃, at time t1, in the candidate AP database. In the example of FIG. 1B, the STA 110 may trigger a roaming condition (to search for a new candidate AP to associate with) upon determining that D₁ exceeds a threshold distance. For example, the threshold distance may correspond with an outer limit of the wireless range of AP1. Upon triggering the roaming condition, the STA 110 may selectively associate with one of the other access points AP2 or AP3 based at least in part on the ranging information RI₂-RI₃ or distances D₂-D₃ stored in the candidate AP database.

For some implementations, the STA 110 may use the ranging information RI₂ and RI₃ to select a “best roaming candidate” among the candidate access points AP2 and AP3. The best roaming candidate may be determined in a number of ways. For example, in some aspects, the best roaming candidate may correspond to the candidate AP that is closest in proximity to the STA 110 at the time of selection. In some other aspects, the best roaming candidate may correspond to a candidate AP that is located in a direction that the STA 110 is moving towards. In yet another aspect, the best roaming candidate may correspond to a candidate AP that is located in a region with the fewest obstructions that could potentially interfere with communications between the STA 110 and the candidate AP.

In the example of FIG. 1B, the STA 110 may select AP2 as the best roaming candidate. For example, the STA 110 may be closer in proximity to AP2 than to either AP1 or AP3 (D₂>D₃>D₁ at time t1). Accordingly, the STA 110 may initiate a roaming operation with respect to AP2. During roaming, the STA 110 may maintain a connection to the WLAN 150 by transferring its communications over to the candidate access point AP2 without disconnecting or disassociating from the currently associated access point AP1. For example, while associated with AN, the STA 110 may send a pre-authentication request, followed by a reassociation request to AP2. The candidate access point AP2 may subsequently communicate with a controller of the WLAN 150 to seamlessly migrate communications with the STA 110 from AP1 to AP2. In some instances, the STA 110 may determine, based on the ranging information RI₁-RI₃, that neither of the candidate access points AP2 or AP3 is likely to perform better than the currently associated access point AP1. Thus, under such circumstances, the STA 110 may choose not to perform roaming.

For simplicity, in the examples of FIGS. 1A and 1B, the selection of a candidate AP has been described solely with respect to ranging information RI₁-RI₃ for the respective access points AP1-AP3. However, in some other implementations, the ranging information RI₁-RI₃ may supplement other metrics that may be used by the STA 110 in selecting a candidate AP in which to associate. For example, the STA 110 may search for candidate APs, identify the candidate APs, or select a particular candidate AP to associate with based on a combination of the ranging information and one or more additional metrics, including but not limited to: signal strength (RSSI), signal-to-noise ratio (SNR), modulation and coding scheme (MCS), or packet error rate (PER). The use of additional metrics may allow the STA 110 to make better-informed decisions as to the expected quality of communications with any of the APs within the WLAN 150.

FIG. 2 shows a sequence diagram depicting a ranging operation 200 that may be used in a candidate AP selection process. For example, the ranging operation 200 may be used in selecting a candidate AP to associate with (such as during a channel scan or roaming operation). In some implementations, the ranging operation 200 may further be used for triggering a roaming condition. As described above with respect to FIGS. 1A and 1B, the ranging operation 200 may be performed by a STA to acquire ranging information for, and determine its distance to, a nearby AP. For some implementations, the ranging operation 200 also may be used to determine additional metrics (such as RSSI) that may aid in the candidate AP selection process. With reference, for example, to the system 100 of FIGS. 1A and 1B, the STA may be an implementation of STA 110 and the AP may be an implementation of any of the access points AP1-AP3.

In the example of FIG. 2, the STA first transmits an FTM request frame (FTM_REQ) to the AP, which responds with an acknowledgement frame (ACK). The exchanging of FTM_REQ and ACK may correspond to a handshake process that signals an intent to perform a ranging operation and also allows the STA and AP to determine whether each device supports capturing timestamps. Assuming that both the STA and AP support capturing timestamps, the AP initiates the ranging operation 200 by transmitting a first FTM frame (FTM₁) to the STA, and captures the time of departure (TOD) of FTM₁ at time t1. The STA receives FTM₁, and captures its time of arrival (TOA), at time t2. In some implementations, the STA also may measure the signal strength (RSSI₁) of the received FTM frame FTM₁. The STA then responds with an ACK, and captures its TOD, at time t3. At time t4, the AP receives the ACK and captures its TOA.

At time t5, the AP transmits a second FTM frame (FTM₂) to the STA. The second FTM frame FTM₂ may include the timestamps captured at times t1 and t4. The STA receives FTM₂ at time t6 and may retrieve the corresponding timestamps. In some implementations, the STA also may measure the signal strength (RSSI₂) of the received FTM frame FTM₂. The STA concludes the ranging operation 200 by transmitting an ACK at time t7, which the AP subsequently receives at time t8. Upon receiving the second FTM frame FTM₂ at time t6, the STA has timestamp values for times t1, t2, t3, and t4 that correspond to the TOD of FTM₁ from the AP, the TOA of FTM₁ at the STA, the TOD of the ACK from the STA (sent in response to FTM₁), and the TOA of the ACK at the AP, respectively. Thereafter, the STA may determine the RTT of the FTM frame exchange as (t4−t1)−(t3−t2). The RTT may then be correlated with a distance value, for example, based on an MCS used for transmitting the FTM frames.

The RSSI values may be used to further augment the candidate AP selection process. For example, while the ranging information may be a more accurate indicator of the distance between the STA and the AP, the RSSI may be a more accurate indicator of the actual quality of the communications link between the STA and the AP. As shown in the example of FIG. 2, the STA may determine at least two RSSI values RSS₁ and RSSI₂ with each ranging operation 200. In contrast, a conventional scanning operation typically yields a single RSSI value, for example, which may be determined from the probe response sent by the AP in response to a probe request. In some aspects, the multiple RSSI values RSSI₁ and RSSI₂ may be used to verify or validate one another. For example, if RSSI₁ is substantially equal to RSSI₂, then the communications link between the AP and the STA may be relatively stable. Thus, as long as the RSSI values RSSI₁ and RSSI₂ are relatively consistent, RSSI₁ or RSSI₂ may be taken into consideration by the STA (in addition to the ranging information) when selecting a candidate AP to associate with.

However, if RSSI₁ is substantially different than RSSI₂, then at least one of the RSSI values RSSI₁ or RSSI₂ may be inaccurate and thus unreliable. Sudden spikes or discrepancies among the RSSI values acquired during the ranging operation 200 may be attributable to temporary obstructions or interference in the wireless medium. For example, if the STA detects substantially inconsistent RSSI values while remaining stationary or at a particular location for a given duration, it is more likely that any sudden drops in RSSI may be attributed to temporary external interference (caused by other objects, wireless devices, or obstructions moving through the medium) rather than a permanent degradation in signal quality. Under such conditions, the STA may either ignore the RSSI values or acquire additional RSSI readings when making decisions pertaining to candidate AP selection (such as triggering a roaming condition or selecting a candidate AP to associate with).

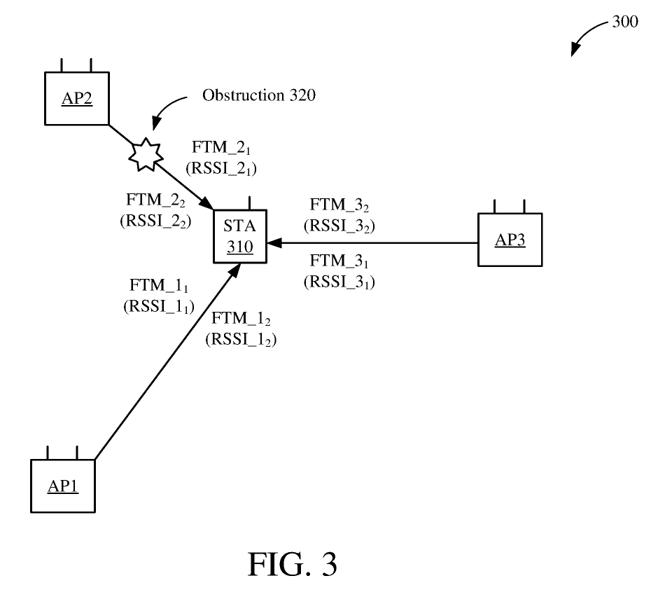

FIG. 3 shows an example wireless system 300 in which a STA may identify candidate APs using FTM frames. The system 300 includes access points AP1-AP3 and a STA 310. With reference, for example, to the system 100 of FIGS. 1A and 1B, the STA 310 may be an implementation of STA 110. In some implementations, the STA 310 may acquire ranging information for each of the access points AP1-AP3 using the ranging operation 200 described above with respect to FIG. 2.

For example, the STA 310 may determine its distance to each of the access points AP1-AP3 by initiating FTM frame exchanges with the respective APs. More specifically, the STA 310 may determine its distance to AP1 based on at least two FTM frames FTM_1₁ and FTM_1₂ transmitted by AP1 to the STA 310. For some implementations, the STA 310 also may determine the signal strength of communications with AP1 based on measured RSSI values RSSI_1₁ and RSSI1₂ of FTM_1₁ and FTM_1₂, respectively. The STA 310 may determine its distance to AP2 based on at least two FTM frames FTM_2₁ and FTM_2₂ transmitted by AP2 to the STA 310. For some implementations, the STA 310 also may determine the signal strength of communications with AP2 based on measured RSSI values RSSI_2₁ and RSSI_2₂ of FTM_2₁ and FTM_2₂, respectively. The STA 310 may determine its distance to AP3 based on at least two FTM frames FTM_3₁ and FTM_3₂ transmitted by AP3 to the STA 310. For some implementations, the STA 310 also may determine the signal strength of communications with AP3 based on measured RSSI values RSSI_3₁ and RSSI_3₂ of FTM_3₁ and FTM_3₂, respectively.

During a candidate AP selection process (after an initial scanning operation or a roaming condition is satisfied), the STA 310 may identify one or more of the access points AP1-AP3 as candidate APs or select one of the access points AP1-AP3 to associate with based at least in part on the ranging information (such as acquired through FTM frame exchanges). In some implementations, the STA 310 may store and periodically update the ranging information for each of the access points AP1-AP3 (such as in a candidate AP database). If the STA 310 is currently associated with one of the access points AP1-AP3, the candidate AP selection process may be triggered once a roaming condition is satisfied (such as when the STA 310 moves at least a threshold distance away from the associated AP). Alternatively, or in addition, the candidate AP selection process may be used to determine when a roaming condition is satisfied (such as when the STA 310 detects a candidate AP that is closer in proximity than the currently associated AP).

In the example of FIG. 3, the STA 310 may determine, based on the ranging information for each of the access points AP1-AP3, that AP2 is the closest candidate AP to the STA 310. However, there may be an obstruction 320 in the wireless medium interfering with communications between the STA 310 and AP2. The obstruction 320 may be a physical object, wireless device, or radiation source that blocks the path of, or otherwise causes interference in, wireless signals transmitted between the STA 310 and AP2. In some aspects, the obstruction 320 may be a temporary obstruction such as, for example, a person or mobile device moving through the wireless medium. In some other aspects, the obstruction 320 may be a more permanent obstruction such as, for example, a wall or a stationary AP placed at a fixed location within the given environment.

If the obstruction 320 is temporary, the signal strength of communications between the STA 310 and AP2 may vary or fluctuate as the obstruction 320 moves through the wireless medium. For example, the obstruction 320 may cause the RSSI of AP2 (as measured by the STA 310) to drop below the RSSI of AP3 at any given instance of time. It is noted that, under conventional scanning operations (whereby the STA 310 would receive a single probe response from each of the access points AP2 and AP3), the STA 310 may select AP3 to associate with, even though AP2 may offer a superior quality of communications over a longer period of time.

However, by using the ranging operation 200 described herein, the STA 310 may detect that the signal strength of AP2 is in flux (such as when RSSI_2₁ is substantially different than RSSI_2₂). Thus, in some implementations, the STA 310 may detect the presence of the obstruction 320 based on the RSSI values RSSI_2₁ and RSSI_2₂ of the received FTM frames FTM_2₁ and FTM_2₂, respectively. Furthermore, the STA 310 may characterize the obstruction 320 as a temporary obstruction based on perceived differences in the RSSI values RSSI_2₁ and RSSI_2₂. In some aspects, upon detecting the temporary obstruction 320, the STA 310 may ignore the signal strength of AP2 when making a candidate AP selection and select AP2 to associate with (based on its closer proximity to the STA 310) even though, in some instances, the signal strength of AP3 may be greater than the signal strength of AP2.

If the obstruction 320 is permanent, the signal strength of communications between the STA 310 and AP2 may remain relatively weak over a longer duration. For example, the obstruction 320 may cause the RSSI of AP2 (as measured by the STA 310) to remain below the RSSI of AP3 for as long as the STA 310 remains in its current location. Thus, by using the ranging operation 200 described herein, the STA 310 may detect that the signal strength of AP2 is relatively stable, although weak compared to AP3 (such as when RSSI_2₁ and RSSI_2₂ are both lower than RSSI_3₁ or RSSI_3₂). In some implementations, the STA 310 may characterize the obstruction 320 as a permanent obstruction based on the consistently low RSSI values RSSI_2₁ and RSSI_2₂. In some aspects, upon detecting the permanent obstruction 320, the STA 310 may select AP3 to associate with (based on its consistently superior signal strength) even though AP2 is closer in proximity to the STA 310.

As described above, the STA 310 may reduce a roaming time by storing and periodically updating the ranging information for each of the access points AP1-AP3 (such as in a candidate AP database). For example, while associated with a particular AP, the STA 310 may continue to monitor the ranging information for each of the access points AP1-AP3. This may allow the STA 310 to more quickly roam to a new candidate AP once a roaming condition has been satisfied (such as when STA 310 is at least a threshold distance away from the associated AP, STA 310 is closer to another candidate AP, etc.). For some implementations, the STA 310 may further reduce a roaming time based at least in part on a neighbor report received from an associated AP. The neighbor report may indicate the presence and locations (such as coordinates) of other APs in the vicinity of the associated AP or within the same wireless network. Thus, the STA 310 may use the location information included in the neighbor report to determine or supplement the ranging information for each of the access points AP1-AP3.

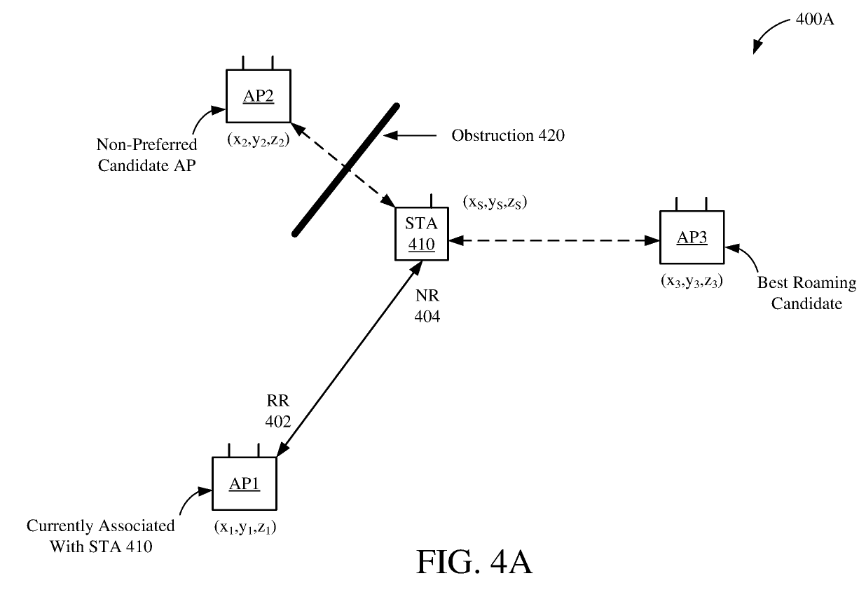

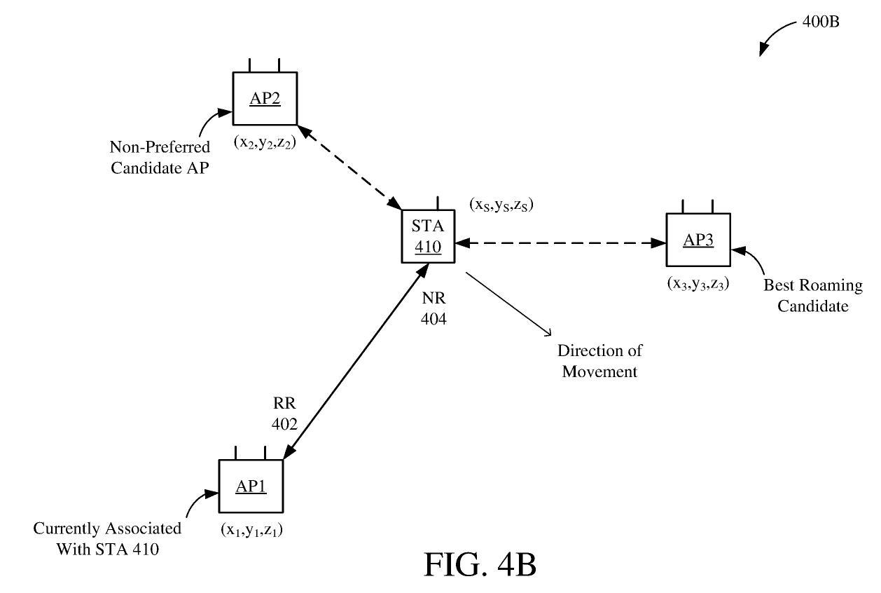

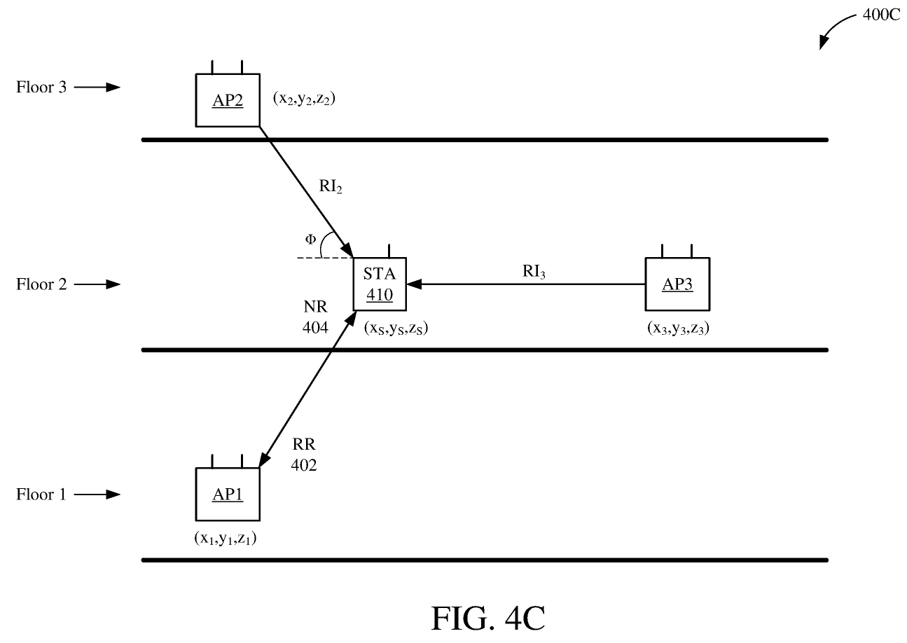

FIGS. 4A-4C show example wireless systems 400A-400C, respectively, in which a STA may identify candidate APs for roaming using neighbor reports. The systems 400A-400C include access points AP1-AP3 and a STA 410. With reference, for example, to the system 100 of FIGS. 1A and 1B, the STA 410 may be an implementation of STA 110. In the examples of FIGS. 4A-4C, the STA 410 may be currently associated with AP1 (the associated AP). In some implementations, the STA 410 may determine ranging information for each of the access points AP1-AP3 based at least in part on a neighbor report (NR) 404 received from AP1 (which may be received upon associating with AP1).

The neighbor report 404 may include location configuration information (LCI) indicating the locations (x,y,z) of known access points near AP1 or in the same network as AP1. For example, the neighbor report 404 may identify the associated AP at a first location (x₁, y₁, z₁), candidate access point AP2 at a second location (x₂, y₂, z₂), candidate access point AP3 at a third location (x₃, y₃, z₃). The STA 410 may then use knowledge of its own location (xs, ys, zs) to determine its distance to each of the access points AP1-AP3. The STA 410 may determine its own location using a number of well-known techniques including, for example, triangulation of radio signals, global positioning system (GPS) location tracking, or based on ranging information for the access points AP1-AP3 (such as acquired through FTM frame exchanges).

In some implementations, the STA 410 may use the location information included with the neighbor report 404 to filter, or narrow down the range of, candidate APs or select the best roaming candidate. More specifically, based on the locations of the access points AP1-AP3 and information about the environment or movement of the STA 410, the STA 410 may eliminate selected access points as potential candidate APs prior to detecting that a roaming condition has been satisfied. This may allow the STA 410 to more quickly and efficiently identify a best roaming candidate (such as from a narrower set of candidate APs) once roaming is triggered.

For example, with reference to FIG. 4A, the STA 410 may detect an obstruction 420 (using ranging techniques described above with respect to FIG. 3 or based on known information about the environment) in the path of communications between the STA 410 and AP2. If the STA 410 determines that the obstruction 420 is permanent, and may significantly interfere with communications between the STA 410 and AP2, the STA 410 may eliminate AP2 as a potential candidate AP (or label AP2 as a “non-preferred” candidate AP) before even determining that a roaming condition has been satisfied. Thus, upon determining that the STA 410 is at least a threshold distance from AP1, the STA 410 may identify AP3 as the only candidate AP within wireless range, and may therefore select AP3 as the best roaming candidate.

In another example, with reference to FIG. 4B, the STA 410 may determine that it is moving in a direction away from AP2 and towards AP3, for example, based on its own location information or ranging information with respect to AP2 and AP3. Thus, even though AP2 may be the closest AP in proximity to the STA 410 at a given instance, the STA 410 may determine that AP3 is likely to provide better communications quality over a longer period of time based on the direction of movement of the STA 410. Accordingly, the STA 410 may eliminate AP2 as a potential candidate AP (or label AP2 as a “non-preferred” candidate AP) before even determining that a roaming condition has been satisfied. Thus, upon determining that the STA 410 is at least a threshold distance from AP1, the STA 410 may identify AP3 as the only candidate AP within wireless range, and may therefore select AP3 as the best roaming candidate.

In yet another example, with reference to FIG. 4C, the STA 410 may determine that it is moving in a planar direction with respect to AP3, and non-planar with respect to AP2, for example, based on an angle of arrival (or an angle of departure) of incoming signals received from the candidate access points AP2 and AP3. For example, each of the access points AP1-AP3 may be located on a different floor (such as floors 1-3) of a building and are therefore at different altitudes z₁-z₃, respectively. When performing ranging operations to determine respective distances between the STA 410 and each of the candidate access points AP2 and AP3, the STA 410 may determine the angle arrival (Φ) of wireless signals (such as FTM frames) carrying ranging information RI₂ and RI₃, respectively. Based on the angles of arrival, the STA 410 may determine that it is located at the same altitude (zs=z₃) or on the same floor (such as floor 2) as AP3. Accordingly, because communications between the STA 410 and AP2 are obstructed by an entire floor (such as that which separates floors 2 and 3), the STA 410 may eliminate AP2 as a potential candidate AP (or label AP2 as a “non-preferred” candidate AP) before even determining that a roaming condition has been satisfied. Thus, upon determining that the STA 410 is at least a threshold distance from AP1, the STA 410 may identify AP3 as the only candidate AP within wireless range, and may therefore select AP3 as the best roaming candidate.

In some implementations, the STA 410 may provide a range report (RR) 402 to AP1, to enable the associated AP to customize or tailor the neighbor report 404 for the particular STA 410. For example, the range report 402 may indicate the distances between the STA 410 and respective access points AP1-AP3. The associated AP may track the location (xs, ys, zs) or movement of the STA 410 based on the information provided with the range report 402. This allows the associated AP to perform the filtering of candidate APs that may otherwise be performed by the STA 410 (such as described above). In some aspects, the associated AP may customize the neighbor report 404 for the STA 410 based on a result of the filtering. For example, the customized neighbor report 404 may indicate “preferred” candidate APs (such as AP3), exclude non-preferred candidate APs (such as AP2), or recommend a best roaming candidate (such as AP3) for the particular STA 410.

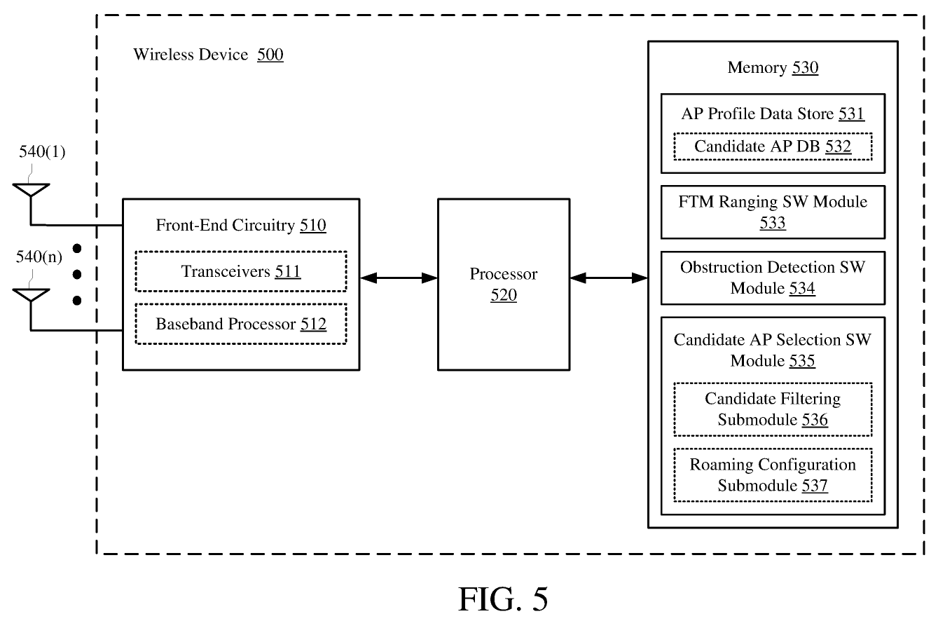

FIG. 5 shows a block diagram of a wireless device 500. The wireless device 500 may be an implementation of STA 110 of FIGS. 1A and 1B, STA 310 of FIG. 3, or STA 410 of FIGS. 4A-4C. The wireless device 500 may include front-end circuitry 510 coupled to a number of antennas 540(1)-540(n), a processor 520, and a memory 530. For purposes of discussion herein, the processor 520 is shown in FIG. 5 as being coupled between the front-end circuitry 510 and the memory 530. For actual implementations, the front-end circuitry 510, the processor 520, or the memory 530 may be connected together using one or more buses (not shown for simplicity).

The front-end circuitry 510 may include one or more transceivers 511 and a baseband processor 512. The transceivers 511 may be coupled to the antennas 540(1)-540(n), either directly or through an antenna selection circuit (not shown for simplicity). The transceivers 511 may be used to communicate wirelessly with one or more STAs, APs, or other suitable wireless devices. The baseband processor 512 may be used to process signals received from the processor 520 or the memory 530 and to forward the processed signals to the transceivers 511 for transmission via one or more of the antennas 540(1)-540(n). The baseband processor 512 also may be used to process signals received from one or more of the antennas 540(1)-540(n) via the transceivers 511 and to forward the processed signals to the processor 520 or the memory 530.

The memory 530 may include an AP profile data store 531 that stores profile information for a plurality of APs. The profile information for a particular AP may include information such as, for example, the AP's SSID, the AP's MAC address, channel information, RSSI values, goodput values, channel state information (CSI), supported data rates, and any other suitable information pertaining to or describing the operation of the AP. In some implementations, the AP profile data store 531 may include a candidate AP database (DB) 531 that stores ranging information for one or more APs in a vicinity, or within wireless range, of the wireless device 500. In some aspects, the ranging information may include, or otherwise indicate, respective distances between the wireless device 500 and each of the one or more APs. In some other aspects, the ranging information may indicate a respective location (such as the coordinates) of each of the one or more APs. In some implementations, the candidate AP database 531 may be periodically updated to reflect the most current ranging information for the one or more APs at a given instance in time.

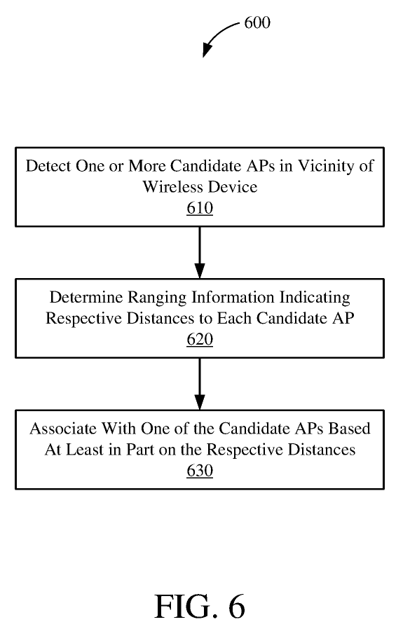

The memory 530 also may include a non-transitory computer-readable medium (such as one or more nonvolatile memory elements, such as EPROM, EEPROM, Flash memory, a hard drive, and so on) that may store at least the following software (SW) modules:
an FTM ranging SW module 533 to acquire ranging information for one or more APs of a wireless network, and to determine respective distances to each of the one or more APs based on the ranging information;
an obstruction detection SW module 534 to detect or classify obstructions in the wireless medium based at least in part on the ranging information; and
a candidate AP selection SW module 535 to identify or select a candidate AP, of the one or more APs, to associate with based at least in part on a proximity of the wireless device 500 to each of the one or more APs, the candidate AP selection SW module including:
   a candidate filtering submodule 536 to selectively filter the one or more APs based at least in part on the ranging information, a presence or classification of obstructions, or an ability to support FTM ranging operations; and
   a roaming configuration submodule 537 to trigger a roaming condition or select a best roaming candidate based at least in part on the ranging information.
      Each software module includes instructions that, when executed by the processor 520, cause the wireless device 500 to perform the corresponding functions. The non-transitory computer-readable medium of the memory 530 thus includes instructions for performing all or a portion of the operations described below with respect to FIGS. 6-10.

The processor 520 may be one or more processors capable of executing scripts or instructions of one or more software programs stored in the wireless device 500 (such as within memory 530). For example, the processor 520 may execute the FTM ranging SW module 533 to acquire ranging information for one or more APs of a wireless network, and to determine respective distances to each of the one or more APs based on the ranging information. The processor 520 also may execute the obstruction detection SW module 534 to detect or classify obstructions in the wireless medium based at least in part on the ranging information. Still further, the processor 520 may execute the candidate AP selection SW module 535 to identify or select a candidate AP, of the one or more APs, to associate with based at least in part on a proximity of the wireless device 500 to each of the one or more APs.

In some aspects, the processor 520 may execute the candidate AP selection SW module 535 to select an initial candidate AP to associate with (such as when attempting to connect to the wireless network). In some other aspects, the processor 520 may execute the candidate AP selection SW module 535 to select a roaming candidate to associate with (such as when a roaming condition is satisfied). Still further, in some aspects, the processor 520 may execute the candidate AP selection SW module 535 to determine when a roaming condition is satisfied. In executing the candidate AP selection SW module 534, the processor 520 may further execute the candidate filtering submodule 536 or the roaming configuration submodule 537. For example, the processor 520 may execute the candidate filtering submodule 536 to selectively filter the one or more APs based at least in part on the ranging information, a presence or classification of obstructions, or an ability to support FTM ranging operations. Further, the processor 520 may execute the roaming configuration submodule 537 to trigger a roaming condition or select a best roaming candidate based at least in part on the ranging information.

FIG. 6 shows a flowchart depicting a range-based candidate AP selection operation 600. The operation 600 may be performed by a wireless device such as, for example, STA 110 of FIGS. 1A and 1B, STA 310 of FIG. 3, STA 410 of FIGS. 4A-4C, or wireless device 500 of FIG. 5. With reference for example to FIGS. 1A-1B, the operation 600 may be performed by the STA 110 in selecting a candidate AP to associate with. For example, the STA 110 may perform the range-based candidate AP selection operation 600 when establishing a connection to a wireless network (such as WLAN 150) or roaming (such as to a candidate AP) within the wireless network.

The wireless device may first detect one or more candidate APs in its vicinity (610). In some aspects, the wireless device may detect the candidate APs by scanning one or more wireless channels (such as through passive or active channel scanning operations) when attempting to connect to the wireless network, as described above with respect to FIG. 1A. In some other aspects, the wireless device may detect the candidate APs by performing ranging operations (such as FTM frame exchanges) with one or more previously-identified APs while being associated with a particular AP of the wireless network, as described above with respect to FIG. 1B.

The wireless device may then determine ranging information indicating respective distances to each of the candidate APs (620). For some implementations, the wireless device may determine the ranging information by exchanging FTM frames with the candidate APs. In some other implementations, the wireless device may determine the ranging information based on known locations or coordinates of the candidate APs and the wireless device, for example, using LCI provided with a neighbor report received from the associated AP. In some aspects, the wireless device may acquire the ranging information upon detecting the ranging capabilities of the candidate APs (such as during a channel scanning operation). In some other aspects, the wireless device may acquire the ranging information in response to a trigger, for example, indicating that a roaming condition is satisfied. Still further, in some aspects, the wireless device may periodically update the ranging information for the candidate APs (such as to capture any changes in the ranging information due to movements of the wireless device).

Finally, the wireless device may associate with one of the candidate APs based at least in part on the respective distances (630). In some aspects, the wireless device may associate with the candidate AP that is closest in proximity to the wireless device at a given time (such as described above with respect to FIGS. 1A and 1B). In some other aspects, the wireless device may weigh additional metrics (such as RSSI) in combination with the ranging information to select a candidate AP that is likely to offer the best wireless performance for the wireless device over an extended period of time. For example, the wireless device may use RSSI information to select a candidate AP that is closest in proximity to the wireless device while having the fewest obstructions or sources of interference along its communication path with the wireless device (such as described above with respect to FIGS. 3 and 4A-4C).

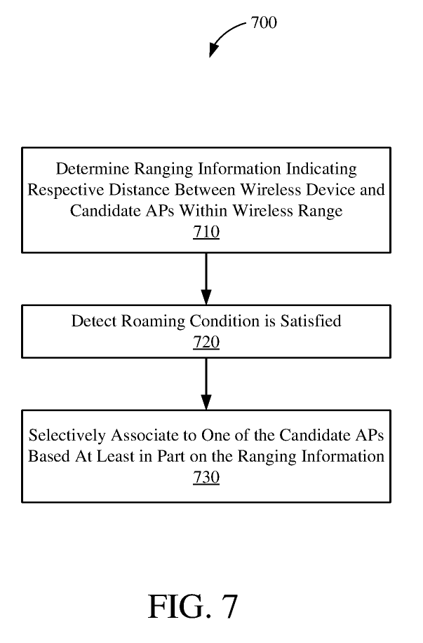

FIG. 7 shows a flowchart depicting a range-based roaming candidate selection operation 700. The operation 700 may be performed by a wireless device such as, for example, STA 110 of FIGS. 1A and 1B, STA 310 of FIG. 3, STA 410 of FIGS. 4A-4C, or wireless device 500 of FIG. 5. With reference for example to FIG. 1B, the operation 700 may be performed by the STA 110 in making roaming decisions (such as determining when to search for candidate APs, identifying the candidate APs, or selecting the best roaming candidate) based at least in part on ranging information.

The wireless device may determine ranging information indicating respective distances between the wireless device and one or more candidate APs within wireless range of the wireless device (710). For some implementations, the wireless device may determine the ranging information based at least in part on a round-trip time (RTT) between wireless signals (such as FTM frames) transmitted to or from the candidate APs. In some other implementations, the wireless device may determine the ranging information based on known locations or coordinates of the candidate APs and the wireless device, for example, using LCI provided with a neighbor report received from the associated AP. In some aspects, the wireless device may periodically acquire the ranging information from nearby candidate APs. In some other aspects, the wireless device may acquire the ranging information upon connecting to the associated AP. Still further, in some aspects, the wireless device may acquire the ranging information in response to a trigger, for example, upon detecting that a roaming condition is satisfied.

The wireless device may further detect that a roaming condition is satisfied (720). For example, the roaming condition may be satisfied when the wireless device determines that the RSSI (or other metric of communications quality) of the associated AP drops below a threshold level. For some implementations, the wireless device may use the ranging information as a trigger for the roaming condition. More specifically, the wireless device may determine whether to search for or identify nearby candidate APs based at least in part on the distance between the wireless device and the associated AP. For example, the roaming condition may be satisfied if the wireless device is at least a threshold roaming distance away from the associated AP. For some implementations, the wireless device may weigh the ranging information with other metrics (such as RSSI) in determining whether the roaming condition is satisfied. For example, as described above with respect to FIGS. 3 and 4A-4C, the ranging information may provide supplemental information about the environment (such as the wireless medium) that may assist the wireless device in making a roaming decision based on detected or predicted channel quality.

Finally, the wireless device may selectively associate with one of the candidate APs based at least in part on the ranging information (730). For example, the wireless device may select a best roaming candidate from the set of candidate APs to roam to or associate with. In some aspects, the best roaming candidate may be the candidate AP that is closest in proximity to the wireless device at a given time (such as described above with respect to FIG. 1B). In some other aspects, the wireless device may weigh other metrics (such as RSSI) in combination with the ranging information to determine the best roaming candidate. For example, the wireless device may select the best roaming candidate as the closest candidate AP having the fewest obstructions or sources of interference along its communications path with the wireless device.

In some implementations, the wireless device may filter the set of candidate APs based at least in part on the presence of obstructions in the environment (such as the wireless medium) or movements of the wireless device (such as described above with respect to FIGS. 3 and 4A-4C). In some other implementations, the associated AP may provide a customized neighbor report to the STA, including a filtered set of candidate APs, based at least in part on ranging information received from the wireless device. The filtering may result in a subset of “preferred” candidate APs that are predicted to offer better communications quality over a longer period of time compared to the associated AP or any “non-preferred” candidate APs. Thus, the wireless device may select the best candidate AP more quickly from the limited subset of preferred candidate APs.

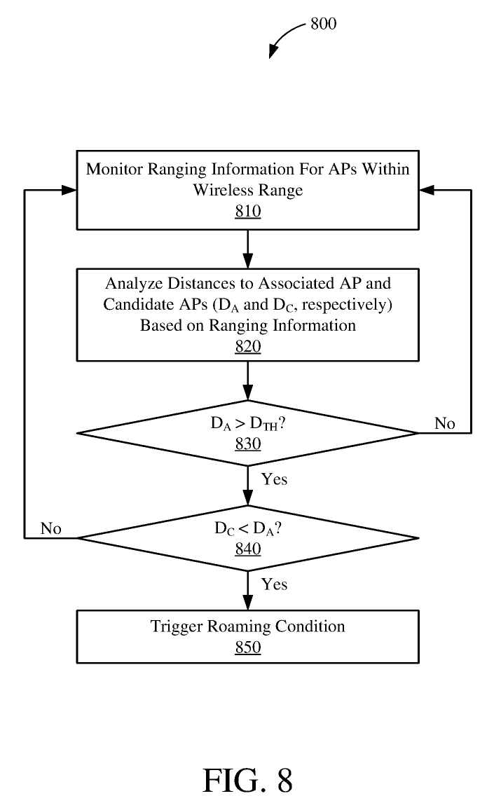

FIG. 8 shows a flowchart depicting an example operation 800 for triggering a roaming condition based on ranging information. The operation 800 may be performed by a wireless device such as, for example, STA 110 of FIGS. 1A and 1B, STA 310 of FIG. 3, STA 410 of FIGS. 4A-4C, or wireless device 500 of FIG. 5. With reference for example to FIG. 1B, the operation 800 may be performed by the STA 110 in determining when to trigger or initiate a roaming operation (such as to associate with a new candidate AP) based on relative distances between the STA 110 and an associated AP or one or more candidate APs.

While associated with a particular AP of the wireless network, the wireless device may monitor ranging information for one or more APs within wireless range (810). For some implementations, the wireless device may periodically perform ranging operations (such as FTM frame exchanges) with the one or more APs to acquire the most current ranging information for each of the one or more APs at a given time. In some other implementations, the wireless device may periodically determine the ranging information based on known locations or coordinates of the APs and the wireless device. In some aspects, the wireless device may store and periodically update the ranging information for each of the APs in a candidate AP database.

The wireless device may further analyze the distances to the associated AP and one or more candidate APs based on the ranging information (820). For example, the wireless device may convert the ranging information to a distance metric. For some implementations, the wireless device may determine whether it is at least a threshold distance away from the associated AP (such as to cause a substantial deterioration in wireless performance). In some other implementations, the wireless device may determine whether it is closer to one of the candidate APs than the currently associated AP (such that one of the candidate APs is likely to provide better wireless performance for the wireless device).

In the example of FIG. 8, the wireless device may first compare its distance from the associated AP with a threshold distance (830). If the wireless device is within the threshold distance of the associated AP (as tested at 830), the wireless device may continue monitoring the ranging information for the one or more APs (810). For example, given the overhead and resources needed to switch communications over to a new AP, it may not be beneficial to trigger a roaming condition if the wireless device is within the threshold distance of the associated AP. However, if the distance between the wireless device and the associated AP exceeds the threshold distance (as tested at 830), the wireless device may then compare its distance from the associated AP with its distance to one or more candidate APs (840).

If the wireless device does not detect a candidate AP that is closer than the associated AP (as tested at 840), the wireless device may continue monitoring the ranging information for the one or more APs (810). For example, if the wireless device is even farther from the candidate APs than the associated AP, it is unlikely that any of the candidate APs will offer better wireless performance than the associated AP. Thus, it may not be beneficial to trigger a roaming condition if the wireless device is unable to detect any candidate APs that are closer in proximity than the associated AP. In some implementations, upon determining that the wireless device is at least the threshold distance away from the associated AP (as tested at 840), the wireless device may initiate a roaming scan to search for candidate APs (which may include previously-unidentified APs) in the current vicinity of the wireless device.

If the wireless device detects one or more candidate APs that are closer than the associated AP (as tested at 840), the wireless device may then trigger a roaming condition (850). For example, upon triggering the roaming condition, the wireless device may roam to, or associate with, one of the candidate APs. For some implementations, the wireless device may immediately roam to the candidate AP that is closest to the wireless device at the given time. In some other implementations, the wireless device may select a best roaming candidate to associate with based on a combination of factors (such as described above with respect to FIGS. 3 and 4A-4C). Still further, for some implementations, the wireless device may perform a roaming scan (such as a conventional channel scan operation) upon determining that the roaming condition is satisfied.

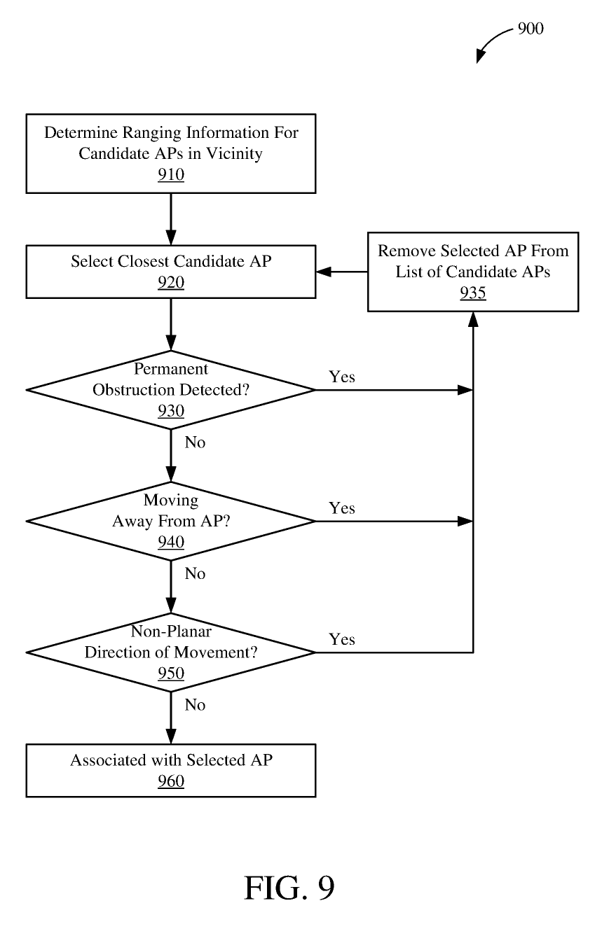

FIG. 9 shows a flowchart depicting an example operation 900 for selecting a candidate AP to associate with based on ranging information. The operation 900 may be performed by a wireless device such as, for example, STA 110 of FIGS. 1A and 1B, STA 310 of FIG. 3, STA 410 of FIGS. 4A-4C, or wireless device 500 of FIG. 5. With reference for example to FIGS. 4A-4C, the operation 900 may be performed by the STA 410 in selecting a best roaming candidate (or initial candidate AP to associate with).

The wireless device may determine ranging information for one or more candidate APs in its vicinity (910). For some implementations, the wireless device may determine the ranging information by exchanging FTM frames with the candidate APs. In some other implementations, the wireless device may determine the ranging information based on known locations or coordinates of the candidate APs and the wireless device, for example, using the LCI provided with a neighbor report received from the associated AP.

The wireless device may then select the candidate AP that is currently closest to the wireless device (920). As described above, the candidate AP that is closest in proximity to the wireless device may be presumed to offer the greatest quality of communications for the wireless device over an extended period of time. However, a number of conditions (such as obstructions in the wireless medium, movements of the wireless device, or movements of the APs) also may affect the quality of communications with a particular AP. Thus, the wireless device may subsequently determine whether any of such conditions are met.

The wireless device may first determine whether there exists a permanent obstruction in the path of communications with the selected AP (930). For example, as described above with respect to FIGS. 3 and 4A, fluctuations in the quality of communications with the selected AP may be attributed to temporary obstructions in the wireless medium, whereas a consistently low communications quality may be caused by a more permanent obstruction. If a permanent obstruction is detected, as tested at 930, the wireless device may remove the selected AP from a corresponding list of candidate APs (935). Alternatively, or in addition, the wireless device may label the selected AP as a non-preferred candidate AP. The wireless device may then proceed to select the next closest candidate AP (920).

If no permanent obstruction is detected, as tested at 930, the wireless device may then determine whether it is moving in a direction away from the selected AP (940). For example, as described above with respect to FIG. 4B, the wireless device may periodically update its ranging information to determine its direction of movement (if any). If the wireless device is moving away from the selected AP, as tested at 940, the wireless device may remove the selected AP from the corresponding list of candidate APs (935). Alternatively, or in addition, the wireless device may label the selected AP as a non-preferred candidate AP. The wireless device may then proceed to select the next closest candidate AP (920).

If the wireless device is not moving away from the selected AP, as tested at 940, the wireless device may then determine whether it is moving in a non-planar direction relative to the selected AP (950). For example, as described above with respect to FIG. 4C, the wireless device may monitor an angle of arrival (or angle of departure) of incoming signals from the selected AP. The wireless device may then determine its altitude or vertical displacement relative to the AP based on the angular information. If the wireless device is moving in a non-planar direction relative to the selected AP, as tested at 950, the wireless device may remove the selected AP from the corresponding list of candidate APs (935). Alternatively, or in addition, the wireless device may label the selected AP as a non-preferred candidate AP. The wireless device may then proceed to select the next closest candidate AP (920).

If no permanent obstruction is detected (as tested at 930), the wireless device is not moving away from the selected AP (as tested at 940), and the wireless device is not moving in a non-planar direction relative to the selected AP (as tested at 950), the selected AP may be presumed to be the best candidate AP. The wireless device may then proceed to associate with the selected AP (960). For some implementations, if the list of candidate APs has been exhausted and the wireless device has not yet associated with a selected AP, the wireless device may then proceed to analyze a list of non-preferred candidate APs. For example, the wireless device may then select the closest non-preferred candidate AP to associate with.

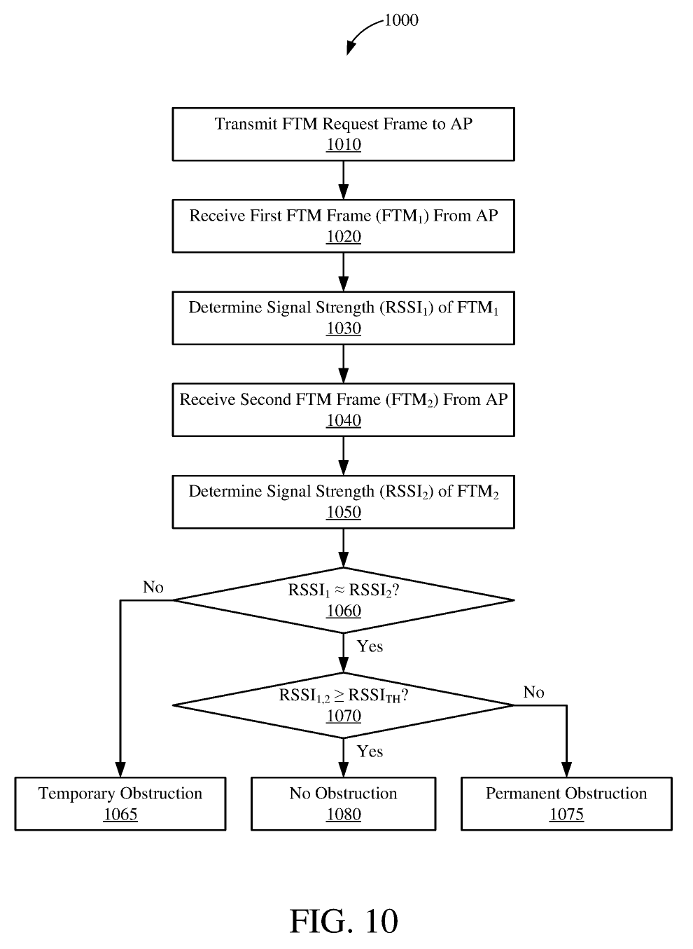

FIG. 10 shows a flowchart depicting an example operation 1000 for detecting and classifying obstructions in a wireless medium based on ranging information. The operation 1000 may be performed by a wireless device such as, for example, STA 110 of FIGS. 1A and 1B, STA 310 of FIG. 3, STA 410 of FIGS. 4A-4C, or wireless device 500 of FIG. 5. With reference for example to FIG. 3, the operation 1000 may be performed by the STA 310 to detect and classify the obstruction 320 based on FTM frame exchanges between the STA 310 and the access points AP1-AP3.

The wireless device may first transmit an FTM request frame to a particular AP (1010). For example, as described above with respect to FIG. 2, the FTM request frame may be used to trigger a ranging operation with the AP. In some aspects, the AP may respond to the FTM request frame by sending an acknowledgement frame (ACK) back to the wireless device. This frame exchange may correspond to a handshake process that signals an intent to perform a ranging operation. More specifically, the ranging operation may be performed by the wireless device to acquire ranging information for, and determine its distance to, the AP.

The wireless device subsequently receives a first FTM frame (FTM₁) from the AP (1020), and determines a signal strength (RSSI₁) of the first FTM frame (1030). The wireless device may measure the signal strength of the first FTM frame, for example, using well-known RF power measurement techniques. The wireless device then receives a second FTM frame (FTM₂) from the AP (1040), and determines a signal strength (RSSI₂) of the second FTM frame (1050). The wireless device may measure the signal strength of the second FTM frame, for example, using well-known RF power measurement techniques.

Finally, the wireless device may compare the signal strengths of the received FTM frames to detect and classify obstructions in the wireless medium. In some implementations, the wireless device may compare the signal strength of the first FTM frame with the signal strength of the second FTM frame to detect the presence of a temporary obstruction (1060). If the signal strength of the first FTM frame is not substantially similar to the signal strength of the second FTM frame, as tested at 1060, the wireless device may determine that a temporary obstruction may be interfering with communications between the wireless device and the AP (1065).

If the signal strength of the first FTM frame is substantially similar to the signal strength of the second FTM frame, as tested at 1060, the wireless device may compare the signal strengths of the received FTM frames with a threshold signal strength (RSSI_{TH}) to detect the presence of a permanent obstruction (1070). If the signal strengths of the first and second FTM frames are below the threshold signal strength, as tested at 1070, the wireless device may determine that a permanent obstruction may be interfering with communications between the wireless device and the AP (1075).

If the signal strength of the first FTM frame is substantially similar to the signal strength of the second FTM frame (as tested at 1060) and the signal strengths of the first and second FTM frames are greater than the threshold signal strength (as tested at 1070), the wireless device may determine that there are no obstructions interfering with communications between the wireless device and the AP (1080).

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices such as, for example, a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A method of operating a wireless device, comprising:
identifying one or more candidate access points (APs) within a vicinity of the wireless device;
exchanging fine timing measurement (FTM) frames with the one or more candidate APs to determine respective distances between the wireless device and each of the one or more candidate APs;
selecting one of the one or more candidate APs to associate with, based at least in part on the FTM frames; and
associating with the selected candidate AP.

2. The method of claim 1, wherein the exchanging of FTM frames is performed when the wireless device is not associated with any AP.

3. The method of claim 1, wherein the selected candidate AP is the candidate AP that is closest to the wireless device.

4. The method of claim 1, wherein the selecting comprises:
detecting signal strengths of the FTM frames received from the one or more candidate APs; and
selecting the one of the one or more candidate APs based at least in part on the respective distances and the signal strengths associated with each of the one or more candidate APs.

5. The method of claim 1, wherein the exchanging of FTM frames is performed when the wireless device is associated with an existing AP, and wherein the associating comprises:
detecting that a roaming condition is satisfied based at least in part on the FTM frames; and
associating with the selected candidate AP upon detecting that the roaming condition is satisfied.

6. The method of claim 5, wherein the roaming condition is satisfied when the wireless device is at least a threshold distance away from the existing AP.

7. The method of claim 5, wherein the roaming condition is satisfied when the wireless device is closer to at least one of the candidate APs than to the existing AP.

8. The method of claim 1, further comprising:
detecting a presence of an obstruction in the vicinity of the wireless device based at least in part on the FTM frames; and
selectively filtering the one or more candidate APs based on the presence of the obstruction.

9. The method of claim 8, further comprising:
detecting signal strengths of the FTM frames received from the one or more candidate APs; and
determining whether the obstruction is temporary or permanent based at least in part on the respective distances and the signal strengths associated with each of the one or more candidate APs.

10. The method of claim 9, wherein the selectively filtering comprises:
filtering the one or more candidate APs if the detected obstruction is permanent.

11. A wireless device, comprising:
one or more processors; and
a memory storing instructions that, when executed by the one or more processors, cause the wireless device to:
identify one or more candidate access points (APs) within a vicinity of the wireless device;
exchange fine timing measurement (FTM) frames with the one or more candidate APs to determine respective distances between the wireless device and each of the one or more candidate APs;
select one of the one or more candidate APs to associate with based at least in part on the FTM frames; and
associate with the selected candidate AP.

12. The wireless device of claim 11, wherein the exchange of FTM frames is performed when the wireless device is not associated with any AP.

13. The wireless device of claim 11, wherein execution of the instructions to select one of the one or more candidate APs causes the wireless device to:
detect signal strengths of the FTM frames received from the one or more candidate APs; and
select the one of the one or more candidate APs based at least in part on the respective distances and the signal strengths associated with each of the one or more candidate APs.

14. The wireless device of claim 11, wherein the exchange of FTM frames is performed when the wireless device is associated with an existing AP, and wherein execution of the instructions to associate with the selected candidate AP further causes the wireless device to:
detect that a roaming condition is satisfied based at least in part on the FTM frames; and
associated with the selected candidate AP upon detecting that the roaming condition is satisfied.

15. The wireless device of claim 14, wherein the roaming condition is satisfied when the wireless device is at least a threshold distance away from the existing AP or when the wireless device is closer to at least one of the candidate APs than to the existing AP.

16. The wireless device of claim 11, wherein execution of the instructions further causes the wireless device to:
detect a presence of an obstruction in the vicinity of the wireless device based at least in part on the FTM frames; and
selectively filter the one or more candidate APs based on the presence of the obstruction.

17. The wireless device of claim 16, wherein execution of the instructions further causes the wireless device to:
detect signal strengths of the FTM frames received from the one or more candidate APs; and
determine whether the obstruction is temporary or permanent based at least in part on the respective distances and the signal strengths associated with each of the one or more candidate APs.

18. A non-transitory computer-readable medium comprising instructions that, when executed by one or more processors of a wireless device, cause the wireless device to perform operations comprising:
identifying one or more candidate access points (APs) within a vicinity of the wireless device;
exchanging fine timing measurement (FTM) frames with the one or more candidate APs to determine respective distances between the wireless device and each of the one or more candidate APs;
selecting one of the one or more candidate APs to associate with based at least in part on the FTM frames; and
associating with the selected candidate AP.

19. The non-transitory computer-readable medium of claim 18, wherein execution of the instructions for associating with the selected candidate AP causes the wireless device to perform operations comprising:
detecting that a roaming condition is satisfied based at least in part on the FTM frames; and
associating with the selected candidate AP upon detecting that the roaming condition is satisfied.

20. The non-transitory computer-readable medium of claim 18, wherein execution of the instructions further causes the wireless device to perform operations comprising:
detecting a presence of an obstruction in the vicinity of the wireless device based at least in part on the FTM frames; and
selectively filtering the one or more candidate APs based on the presence of the obstruction.
